(19) United States
(12) Patent Application Publication
(10) Pub. No.: US 2020/0338958 A1
(43) Pub. Date: Oct. 29, 2020

(54) Leakage Sensor, Heating Unit, Absorption Cooling Device, Vehicle Including the Absorption Cooling Device and Method for Operating the Same

(71) Applicant: Dometic Sweden AB, Solna (SE)

(72) Inventor: Anton Lundqvist, Älvsjö (SE)

(21) Appl. No.: 16/855,164

(22) Filed: Apr. 22, 2020

(30) Foreign Application Priority Data
Apr. 25, 2019 (DE) 1020192059082

(51) Int. Cl. B60H 1/00; F25B 35/02; F25B 49/04; B60H 1/32; G01M 3/40

(52) U.S. Cl. CPC B60H 1/00978; F25B 35/02; F25B 49/04; F25B 2315/003; G01M 3/40; F25B 2500/222; B60H 1/3201

(57) ABSTRACT

A leakage sensor for a heating unit of an absorption cooling device for a recreational vehicle, a heating unit, an absorption cooling device, a vehicle and a method for operating an absorption cooling device are provided. The leakage sensor uses sensor pins to detect cooling fluid leaking from the boiler of the heating unit of the absorption cooling device into the boiler insulation by measuring the electrical resistance and/or conductivity within the boiler insulation.

The present embodiments relate to a leakage sensor for an absorption cooling device for a recreational vehicle, for example a camper, a caravan or a mobile home, a heating unit for an absorption cooling device for a recreational vehicle, an absorption cooling device for a recreational vehicle, a vehicle including the absorption cooling device and a method for operating an absorption cooling device.

Generally, leakage sensors for absorption cooling devices for recreational vehicles are known from the prior art and fulfil their purpose regarding the safety of the devices and governmental safety regulations. Commonly known leakage detection systems for such kind of absorption cooling devices use, for example, ammonia sensors, temperature sensors and/or software-based control devices. The leakage of cooling fluid from an absorption cooling device usually leads to increased temperature within the system and may also lead to other types of malfunction of the device. Known devices, thus, rely on methods monitoring the temperature preferably in the immediate vicinity of the absorption cooling device—for example, on the outer shell of the insulation or at the bottom of the absorption cooling device—or even within the cooling cycle itself to detect an occurring leakage. The cooling liquid usually contains ammonia. Hence, also the use of ammonia sensors to detect leaking cooling liquid is an applied principle.

The instant embodiments provide improved protection means for absorption cooling devices for recreational vehicles and to provide a reliable system for safely operating an absorption cooling device for a recreational vehicle.

These objectives are met by a leakage sensor, a heating unit, an absorption cooling device, a vehicle, and a method as defined in the independent claims.

The present embodiments use a new approach to detect leakage of cooling fluid from an absorption cooling device. The present embodiments make use of the fact that the conductivity of common insulation materials increases significantly as soon as any form of liquid is present within the insulation. In case cooling liquid leaks from the boiler of the heating unit of an absorption cooling device into the insulation surrounding these components, an increase in conductivity within the insulation can be measured and, thus, by detecting this increase in conductivity within the insulation a leakage can be quickly detected. The temperature and pressure within the boiler of the heating unit of an absorption cooling device make the boiler generally the most likely place for a leakage to occur.

Hence, according to the present embodiments a leakage sensor is provided which is measuring the resistance and/or conductivity within the insulation of a boiler of an absorption cooling device. The leakage sensor according to the present embodiments is, thus, capable of detecting a leakage in a quick and reliable manner. In addition, a heating unit for an absorption cooling device is provided which can be provided with leakage detection capabilities at low manufacturing complexity. Moreover, an absorption cooling device is provided which is equipped with low cost leakage detection capabilities. Additionally, a vehicle is provided which is safe from the risks accompanying a cooling liquid leakage. Finally, a method is provided for operating an absorption cooling device with mentioned leakage detection capabilities.

According to the present embodiments, a leakage sensor for an absorption cooling device for a recreational vehicle, and in particular for an absorption refrigerator for a recreational vehicle is provided. The absorption cooling device has a heating unit with a boiler. The leakage sensor has a voltage source and at least two sensor pins. Furthermore, the leakage sensor comprises a voltage detection unit connected in series with the two sensor pins or a thermistor connected in parallel with the sensor pins. At least one sensor pin is electrically connected to one pole of the voltage source and at least one other sensor pin is connected to the other pole of the voltage source or to ground. The sensor pins are configured to be located in a boiler insulation of the heating unit of the absorption cooling device. Thus, according to the present embodiments a leakage sensor is provided which is measuring the conductivity within the insulation of a boiler of an absorption cooling device and which is therefore capable of detecting a leakage of cooling liquid in a quick and reliable manner. Therefore, the risks involved with the leakage of cooling liquid such as overheating of the boiler and other types of malfunction of the absorption cooling device can be minimized. Such a leakage sensor can be easily applied due to its low complexity in manufacturing even to existing systems if desired. In combination with existing leakage detection systems, this leakage sensor can be used to create redundancy and, thus, the increase the product safety of the absorption cooling device.

In some optional embodiments, each sensor pin of the leakage sensor is combined with at least one other sensor pin to form a sensor unit. The sensor pins of a sensor unit are spaced at distances from each other. In particular, the distance the sensor pins are spaced from each other is less than 2.0 cm, for example less than 1.0 cm and further preferred less than 0.5 cm. However, the sensor pins are not in direct contact with each other. Thus, the pins of the leakage sensor are going to short circuit through the liquid in case of a leak which is significantly reducing the resistance between the two pins. The closer the sensor pins are located to each other, the more sensible the sensor is towards small amounts of leaking cooling liquid. Generally, it is desirable that the sensor pins forming the sensor units be distributed throughout the whole volume of the boiler insulation to cover all possible points of leakage and condensation of leaking cooling liquid to maximize the security of detection of a leakage.

In some embodiments, the voltage detection unit or the thermistor is configured in such a way that it detects a resistance. In particular the thermistor (when provided) and the voltage source are components of the absorption cooling device itself. The sensor pins and the voltage detection unit (when provided), are only connected to the thermistor (when provided) and the voltage source of the absorption cooling device. By detecting a resistance in the insulation, for example through the use of a commonly known voltage bridge, the leakage sensor is able to detect leakage of cooling liquid from the absorption cooling device by comparing the detected resistance to, for example, predetermined desired, reference and/or threshold values. Through the use of components that are commonly already present in absorption cooling devices, anyway—such as for example a voltage source or a thermistor—the costs and manufacturing complexity of the leakage sensor is minimized. The leakage sensor can be integrated into existing systems with a minimal use of additional components and minimum effort.

In some embodiments, the leakage sensor has only one sensor unit with two sensor pins, wherein one of the sensor pins is provided as electrode sheet and the other one of the sensor pins is provided as wire mesh. The sensor pin provided as wire mesh is oriented parallel with respect to the sensor pin provided as electrode sheet. Between the sensor pin provided as electrode sheet and the sensor pin provided as wire mesh a layer of non-conducting and liquid permeable material is provided. Moreover, the wire mesh is may be oriented pointing towards a position of expected leakage. With the sensor pin provided as wire mesh pointed towards a position of expected leakage, the leaking cooling fluid coming from the boiler, passes through the wire mesh and the adjoining liquid permeable material to come into contact with the sensor pin provided as electrode sheet. The electrode sheet will not only function as an electrode but also as a trap for the leaking cooling liquid, thus, further increasing the probability of creating a liquid conducting bridge between the two sensor pins. The sensor pin provided as a wire mesh can have any other geometrical form allowing transition of leaking cooling liquid therethrough.

In some embodiments, at least two sensor pins forming a sensor unit are provided as wires being intertwined with each other, wherein one of the two sensor pins is covered with a layer of non-conducting and liquid permeable material. Thus, a sensor unit is provided which can be flexibly deployed throughout the insulation of the boiler. This way, locations of the boiler with an increased risk of leakage, such as welding areas, can be targeted specifically.

In some embodiments, at least two sensor pins forming a sensor unit are provided in a fork-like manner. That means the sensor pins are positioned to interlock with each other and to be separated from each other by a layer of non-conducting and liquid permeable material. Thus, this sensor unit provides close-knit coverage of large volumes of insulation to further decrease the probability of leakage without detection.

In some embodiments, one of the sensor pins is an actual carbon steel cooling unit. Thus, a configuration is provided with which one of the sensor pins is already part of the absorption cooling device and the complexity of the leakage sensor is further reduced.

The sensor pins may be made of galvanized steel and/or the non-conducting and liquid permeable material has sufficient heat resistance and in particular is made of glass fiber or paper. Thus, the leakage sensor is provided with durable components preventing material failure, false alarms and other kinds of malfunctions.

In some embodiments, the layer of non-conducting and liquid permeable material has a thickness of less than 10 mm and particularly less than 5 mm. Thus, the pins can be located close to each other, increasing sensibility of the sensor towards small amounts of leaking cooling liquid.

Also according to the present embodiments, a heating unit for an absorption cooling device for a recreational vehicle, and in particular for an absorption refrigerator for a recreational vehicle is provided. The heating unit has a boiler provided with a boiler insulation and a heating element, wherein the heating element is in particular an electrical heating element. The boiler is configured to be coupled to an absorber and a condenser of the absorption cooling device. The heating unit has a leakage sensor as described above, wherein the sensor pins of the leakage sensor are located in the boiler insulation of the heating unit. Thus, the component of the heating unit where a material failure causing leakage is most likely to occur, the boiler, is equipped with leakage detection capabilities. Such a heating unit fulfils safety requirements at reduced cost and with minimized manufacturing complexity.

In some embodiments, the boiler insulation surrounds the boiler and the heating element in radial direction with respect to the longitudinal axis of the boiler. Thus, the boiler is entirely covered in insulation with leakage detection capabilities to ensure reliable detection of any occurring leakage.

In some embodiments, the leakage sensor is provided as described above, the sensor having only one sensor unit with two sensor pins, wherein one of the sensor pins is provided as electrode sheet and the other one of the sensor pins is provided as wire mesh. The sensor pin provided as wire mesh is surrounding the boiler in the radial direction with respect to the longitudinal axis of the boiler. Between the sensor pin provided as wire mesh and the boiler a layer of non-conducting and liquid permeable material is provided. Furthermore, the sensor pin provided as electrode sheet is surrounding the sensor pin provided as wire mesh in the radial direction with respect to the longitudinal axis of the boiler. In particular, the boiler is covered with some mineral wool. With the sensor pin provided as wire mesh surrounding the boiler in the radial direction, the leaking cooling fluid coming from the boiler, passes through the wire mesh and the adjoining liquid permeable material to come into contact with the sensor pin provided as electrode sheet. The electrode sheet will therefore not only function as an electrode but also as a trap for the leaking cooling liquid thus further increasing the probability of creating a liquid conducting bridge between the two sensor pins. The sensor pin provided as a wire mesh can have any other geometrical form allowing transition of leaking cooling liquid therethrough.

In some embodiments, the heating unit is provided with various sensor units. The sensor units are distributed in the boiler insulation along the length and the depth of the boiler insulation. In particular the sensor units are provided also in an area of the boiler insulation in which the occurring temperature is expected to be of about 100° C. and less. Thus, the probability of undetected leakage is further reduced due to the dense deployment of sensor units throughout the boiler insulation.

Furthermore, according to the present embodiments an absorption cooling device for a recreational vehicle, in particular an absorption refrigerator for a recreational vehicle is provided. The absorption cooling device according to the present embodiments has a heating unit as described above, a condenser, an evaporator, an absorber coupled to each other, and a control system. Thus, in accordance with the present embodiments an absorption cooling device is provided which is equipped with reliable, quick leakage detection capabilities at minimized technical effort and minimized costs.

In some embodiments, the control system is connected to the voltage detection unit or to the thermistor. The control system transmits an error signal and/or shutting down the absorption cooling device, in particular the heating unit of the absorption cooling device when determining the occurrence of leakage based on the signals received from the voltage detection unit or from the thermistor. Thus, the safety of the user of the absorption cooling device can be increased even in the unlikely event of a leakage of cooling liquid.

Also according to the present embodiments, a vehicle, in particular a recreational vehicle is provided. The vehicle is provided with an absorption cooling device according to the present embodiments and as described above. Thus, the user can enjoy the benefits of the absorption cooling device while being reliably safe from risks accompanying leakage of cooling liquid from the boiler of the heating unit of the absorption cooling device.

Furthermore, a method for operating an absorption cooling device according to the present embodiments, in particular an absorption cooling device as described above comprises the following steps:
Measuring an electrical resistance and/or conductivity in the periphery of the boiler of the absorption cooling device;
comparing the measured data with at least one predetermined desired, threshold and/or reference value; and
controlling the absorption cooling device, in particular the heating unit of the absorption cooling device depending on the received result of the conducted comparison.

Thus, the comparison of the measured data with at least one predetermined desired value, threshold value and/or reference value allows reliable detection of leakages. The absorption cooling device is, hence, controlled in a safe manner. The at least one predetermined desired value, threshold value and/or reference value is chosen to avoid false alarms thereby ensuring stable operation of the absorption cooling device.

In some embodiments, measuring the electrical resistance and/or conductivity in the periphery of the boiler is performed continuously, periodically and/or selectively. Thus, reliable monitoring of the system can be adapted to safety and other requirements and safe and stable operation of the absorption cooling device is ensured.

In some embodiments, the measured periphery of the boiler is in the inner of the boiler insulation of the absorption cooling device. Thus, quick detection of any occurring leakage and swift application of corresponding counter measures are provided.

In some embodiments, besides the electrical resistance and/or the conductivity, also other properties and/or parameters of the absorption cooling device are measured and considered in the conducted comparison. Thus, redundancy is established to further increase the security of the system.

In some embodiments, at least one of the other properties and/or parameters of the absorption cooling device is a flow rate, velocity and/or current and/or other similar of these characteristics indicating properties and/or parameters of the absorption cooling device. Thus, by providing insight into properties and/or parameters of the absorption cooling device, redundant control measures can be easily implemented to ensure safety of the absorption cooling device.

In some embodiments, the absorption cooling device, and in particular the heating unit of the absorption cooling device is shut down, when a result of the conducted comparison indicates a non-negligible leakage for the absorption cooling device and/or a secure continuation of the operation of the absorption cooling device cannot be guaranteed. Thus, risks accompanying the leakage of cooling fluid from the absorption cooling device can be minimized and a safe and stable operation of the device is ensured.

A more complete appreciation of the present embodiments and many of its detailed features and attendant advantages will be readily obtained as the same becomes better understood with reference to the following detailed description when considered in connection with the accompanying figures, wherein:

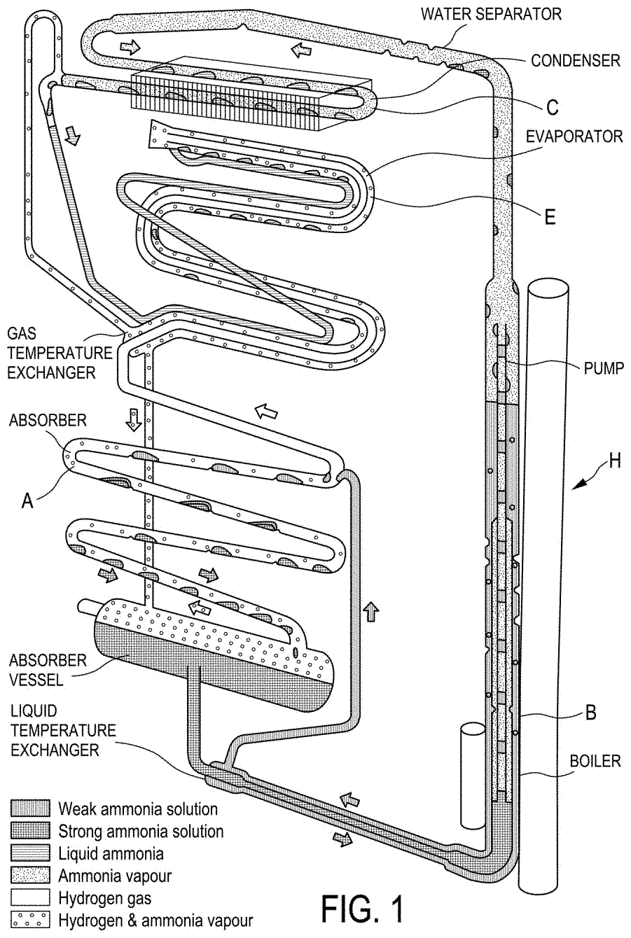

FIG. 1 shows an example of a cooling cycle of an absorption cooling device;

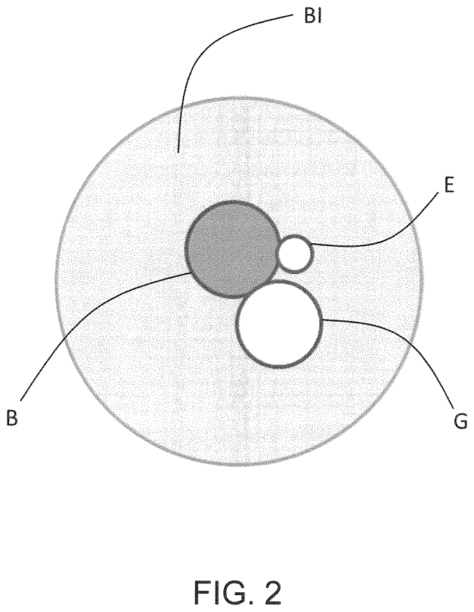

FIG. 2 is a cross section showing a schematic arrangement of the elements surrounding the boiler of a heating unit of an absorption cooling device;

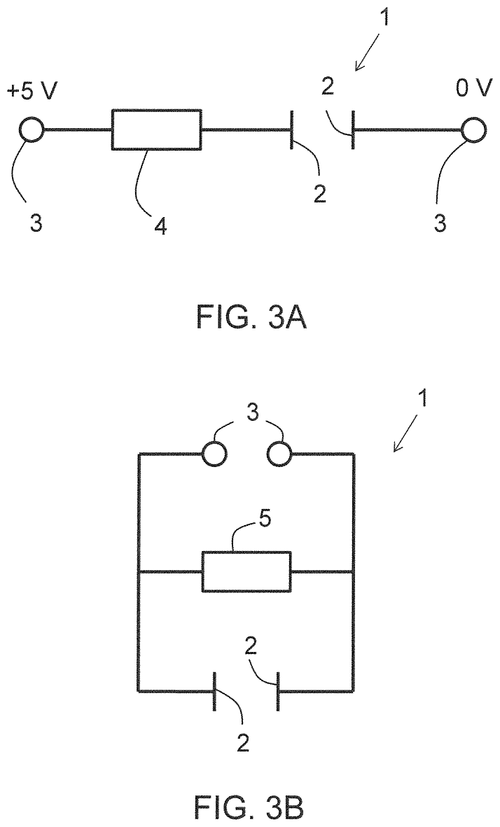

FIG. 3A shows an exemplary electrical circuit of a leakage sensor using a voltage detection unit to measure electrical resistance and/or conductivity;

FIG. 3B shows an exemplary electrical circuit of a leakage sensor using a thermistor to measure electrical resistance and/or conductivity;

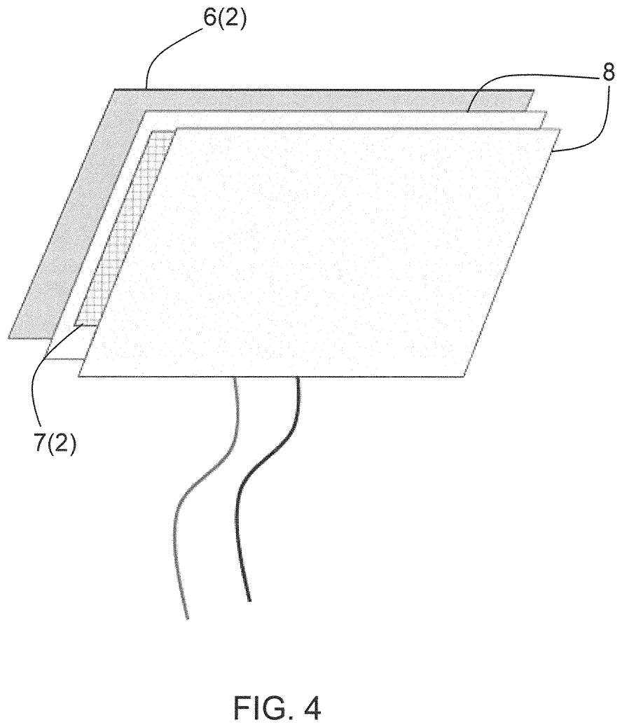

FIG. 4 shows one embodiment of a sensor unit provided with an electrode sheet and a wire mesh as sensor pins;

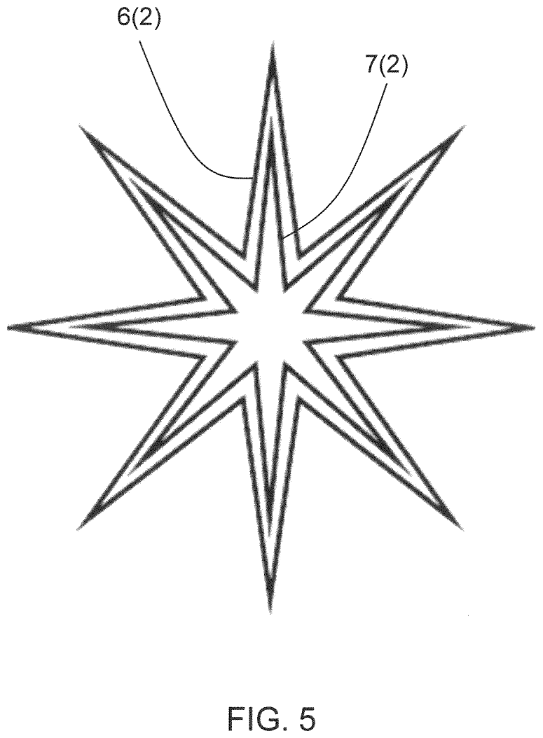

FIG. 5 shows a schematic arrangement of the sensor unit shown in FIG. 4 within the boiler insulation of a heating unit of an absorption cooling device;

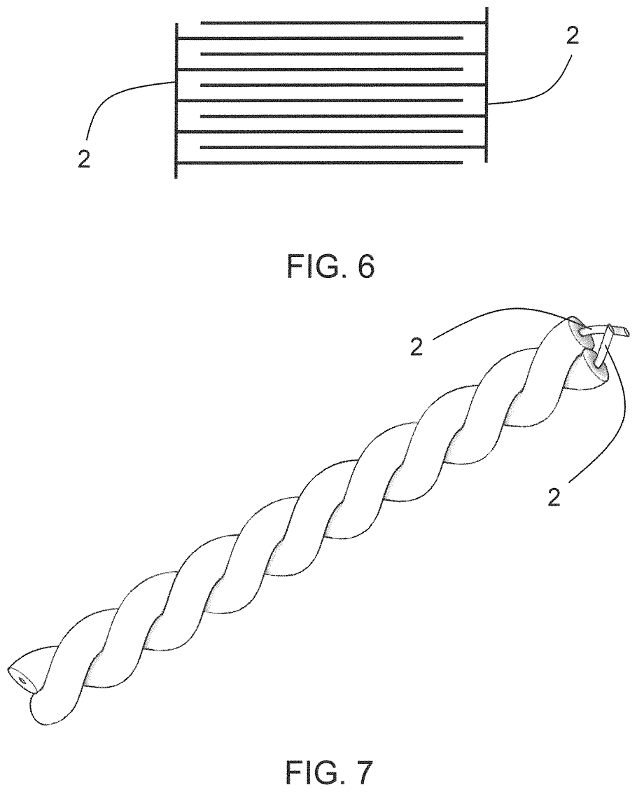

FIG. 6 shows a schematic arrangement of sensor pins provided in a fork-like manner;

FIG. 7 shows a schematic arrangement of sensor pins provided as intertwined with each other; and

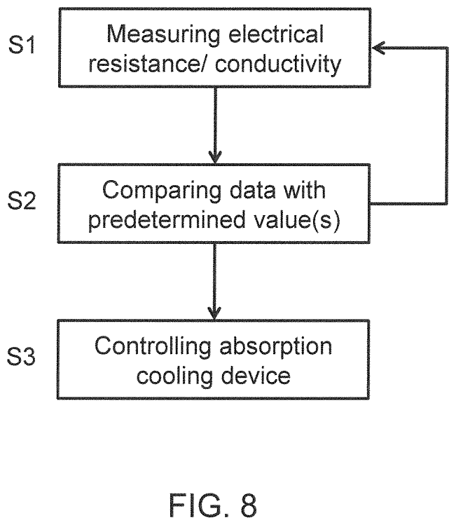

FIG. 8 shows a flow chart of a method for operating an absorption cooling device.

Selected embodiments will now be described with reference to the accompanying figures, wherein like reference characters designate corresponding or identical elements throughout the various figures.

In FIG. 1, an exemplary cooling cycle of an absorption cooling device, such as an absorption refrigerator, is illustrated. Basically, the cooling cycle of an absorption cooling device includes a heating unit H with a boiler B, an absorber A and a condenser C. The boiler B of the heating unit H is where the highest temperatures and pressures occur within the cooling cycle of the absorption cooling device. Therefore, the material of the boiler and its surrounding elements is put under higher strain than the material in other sections of the cooling cycle, making it the most likely point of failure and, thus, leakage of cooling liquid. The high temperatures of the cooling liquid in the boiler B also result in an increased risk of overheating of the surrounding material including further damages to surrounding components or other kind of malfunction occurs here.

The present embodiments use the finding that the conductivity of dry insulation material is significantly lower than that of commonly used cooling liquids. In case of leakage at the boiler, cooling liquid enters into the insulation material surrounding the boiler, thus, increasing the electric conductivity of the insulation material. By measuring the resistance and/or the electric conductivity within the boiler insulation of the heating unit of an absorption cooling device, the detection of leaking cooling liquid is possible.

A point of leakage is, naturally, not known before the leakage occurs. It is therefore desirable, that as broad a range of potential points of leakage at the boiler B of the heating unit of the absorption cooling device be covered by a leakage sensor to maximize the likelihood of leakage detection.

The cross section in FIG. 2 shows a schematic arrangement of the boiler B, an electrical heating element E and a gas central tube G within a boiler insulation BI. Within the absorption cooling device the pressure is higher than within the surrounding environment. Therefore, the boiling temperature of the cooling liquid within the system will be above the boiling temperature of water or ammonia at atmospheric pressure. After a leakage, the cooling liquid will therefore evaporate at first. However, the vaporized cooling liquid will then have to sustain its vapor state by its own temperature. This leads to cooling of the vapor and condensation of the cooling liquid within the boiler insulation BI. Condensed cooling liquid will, of course, amplify the effect of increased conductivity within the boiler insulation BI compared to vaporized cooling liquid. Furthermore, the salt content of common cooling liquids is very high. Thus, salt will be left behind when the cooling liquid evaporates. The salt not only further increases conductivity of the boiler insulation BI but also prevents that all of the cooling liquid evaporates, therefore aiding in creating a conductive bridge between sensor pins provided within the boiler insulation BI.

FIG. 3A illustrated an example of an electrical circuit of a leakage sensor 1 for an absorption cooling device. The leakage sensor 1 has a voltage source 3 and two sensor pins 2. Furthermore, the leakage sensor 1 comprises a voltage detection unit 4 being connected in series with the two sensor pins 2. One sensor pin 2 is connected to the 5V DC-pole of the voltage source 3 via the voltage detection unit 4. The other sensor pin 2 is connected to the other pole of the voltage source 3. The sensor pins 2 are configured to be located in a boiler insulation BI as, for example, shown in FIG. 2. Via the voltage detection unit 4, the electrical resistance and/or conductivity between the sensor pins 2 is measured using, for example, a commonly known voltage bridge. In case leaking cooling fluid gets between the two sensor pins, the electrical resistance between the sensor pins 2 decreases/the conductivity increases and the leakage can, thus, be detected by the control system of the absorption cooling device, to which the leakage sensor 1 is connected.

The electrical circuit of a leakage sensor 1 illustrated in FIG. 3B is an alternative to that illustrated in FIG. 3A. Here, a thermistor 5 is connected in parallel with the two sensor pins 2 instead of the voltage detection unit 4 in FIG. 3A. The sensor pins 2 are again connected to the two poles of the voltage source 3. Both the thermistor 5 and the voltage source 3 are commonly used components in absorption cooling devices. The thermistor 5 is used to measure the temperature within the absorption cooling device. Such a thermistor 5 typically has a resistance in the range of 1 to 30 kOhm. The control system of the absorption cooling device is used to measure the resistance of the thermistor 5 and convert this resistance into a temperature. The thermistor 5 is typically connected to a stabilized voltage source 3 on the circuit board. If the sensor pins 2 are connected in parallel to the thermistor 5, this will have no impact during normal operation since the electrical connectivity between the sensor pins 2 is negligible. In case of a leakage, however, the conductivity of the cooling liquid will rapidly reduce the resistance between the sensor pins 2 and the mixed system resistance will be affected. This will indicate a temperature out of range for the thermistor 5 and the control system can react accordingly. The resistance of the thermistor 5 and the expected resistance between the sensor pins 2 in case of leakage must, of course, be matched to provide sufficient sensitivity and reliability.

The two sensor pins 2 in FIGS. 3A and 3B form a sensor unit and the sensor pins of the sensor unit are spaced apart from each other at distances of less than 2.0, preferably less than 1.0 cm and in particular less than 0.5 cm to increase the likelihood of a conductive bridge forming between them in case of leakage. One of the sensor pins 2 can also be the actual carbon steel cooling unit of the absorption cooling device.

FIG. 4 illustrates one embodiment of a sensor unit. Here, the two sensor pins 2 are provided as electrode sheet 6 and wire mesh 7. Both the electrode sheet 6 and the wire mesh 7 are preferably manufactured from galvanized steel but can also be made of any other suitable material. The wire mesh 7 and the electrode sheet 6 are oriented parallel with respect to each other and between them a layer of non-conducting and liquid permeable material is provided. In particular, the wire mesh 7 is embedded within a pocket of two sheets of glass fiber felt 8. In this configuration, the sensor unit can be oriented with the wire mesh 7 pointing towards a position of expected leakage. Thus, leaking cooling fluid can pass through the wire mesh and the glass fiber felt 8 but not through the electrode sheet 6. If the cooling liquid is still in vaporized form, the electrode sheet 6 will help to capture the cooling fluid and to accelerate the condensation and, thus, to detect leaking cooling fluid. Preferably, such a sensor unit is covering the whole length of the boiler B to provide leakage detection at all possible points of material failure. It can, for example, be wrapped around the boiler insulation BI.

In FIG. 5, one possible arrangement of the sensor unit illustrated in FIG. 3 within the boiler insulation BI of a heating unit H of an absorption cooling device is schematically shown. As mentioned before, within the concept of the present embodiments it is one intention to cover as many points of potential leakage as possible as well as all depths of the boiler insulation BI to be able to capture and detect leaking cooling fluid as quickly as possible. The configuration shown in FIG. 5 places the wire mesh 7 within the encasing electrode sheet 6. Both are arranged in form of a star within the boiler insulation BI to both cover locations close to and farther away from the boiler B. The depiction in FIG. 5 is to be understood as a cross section comparable to that in FIG. 2. Both the electrode sheet 6 and the wire mesh 7 preferably cover the entire length of the boiler B to ensure maximized leakage detection.

Another possible arrangement of sensor pins is schematically shown in FIG. 6. Here, the two sensor pins 2 forming a sensor unit are provided in a fork-like manner. That means, the two sensor pins 2 forming a sensor unit are positioned interlocking with each other and separated from each other by layers of non-conducting and liquid permeable material. These kinds of sensor pins 2 are then pushed into the boiler insulation BI from the side of the boiler B and from the outside. Thus, short distances between the sensor pins 2 can be ensured through the depth and height of the boiler insulation BI. This again maximizes the possibility of leakage detection.

A further preferable arrangement of sensor pins can be seen in FIG. 7. In this embodiment, the two sensor pins 2 forming the sensor unit are provided as wires each being covered with a layer of non-conducting but liquid permeable material and being intertwined with each other. Such a sensor unit can be deployed highly flexible throughout the insulation of the boiler, such that in particular critical locations of the boiler showing an increased risk of occurring leakage can be covered with the sensor pins 2.

FIG. 8 illustrates the flow chart of a method for operating an absorption cooling device. This method uses a leakage sensor 1 as described above, being provided in the boiler insulation BI of a boiler B of a heating unit H of an absorption cooling device, such as an absorption cooling refrigerator, for a recreational vehicle. Step S1 of the method comprises measuring the electrical resistance and/or conductivity in the periphery of the boiler B of the absorption cooling device. In step S2, the measured data is compared with at least one predetermined desired, threshold and/or reference value. Depending on the received result of the conducted comparison, the absorption cooling device, in particular the heating unit of the absorption cooling device is controlled in step S3.

Step S1 is performed continuously, periodically and/or selectively. The periphery of the boiler B of the absorption cooling device is the inner of the boiler insulation BI of the absorption cooling device. During step S1 also other properties and/or parameters of the absorption cooling device can be measured and then considered in step S2 besides the electrical resistance and/or conductivity. These other properties and/or parameters may contain a flow rate, velocity and/or current and/or other similar of these characteristics indicating properties and/or parameters of the absorption cooling device.

In case the comparison conducted in step S2 indicates a non-negligible leakage for the absorption cooling device and/or a secure continuation of the operation of the absorption cooling device cannot be guaranteed, the absorption cooling device, and in particular the heating unit H of the absorption cooling device is shut down and/or not restarted in step S3.

### REFERENCE NUMERALS

1 leakage sensor
2 sensor pin
3 voltage source
4 voltage detection unit
5 thermistor
6 electrode sheet
7 wire mesh
8 glass fiber felt
A absorber
B boiler
BI boiler insulation
C condenser
E electrical heating element
G gas central tube
H heating unit
S1 to S3 step

1. A leakage sensor for an absorption cooling device for a recreational vehicle, the absorption cooling device having a heating unit with a boiler, comprising:
a voltage source and at least two sensor pins;
a voltage detection unit connected in series with the two sensor pins or a thermistor connected in parallel with the sensor pins;
wherein at least one sensor pin is electrically connected to one pole of the voltage source and at least one other sensor pin is connected to the other pole of the voltage source or to ground, and wherein the sensor pins located in a boiler insulation of the heating unit of the absorption cooling device.

2. The leakage sensor of claim 1,
wherein each sensor pin is combined with at least one other sensor pin to form a sensor unit;
wherein the two sensors pins are not in direct contact with each other;
wherein the sensor pins of a sensor unit in particular are spaced at distances from each other of less than 2.0 cm, preferably less than 1.0 cm and further preferably of less than 0.5 cm.

3. The leakage sensor of claim 1,
wherein the voltage detection unit or the thermistor is configured in such a way that it detects a resistance, wherein in particular the thermistor, when provided, and the voltage source are components of the absorption cooling device itself, and the sensor pins and the voltage detection unit, when provided, are only connected to the thermistor, when provided, and the voltage source of the absorption cooling device.

4. The leakage sensor of claim 1,
wherein the leakage sensor has only one sensor unit with two sensor pins;
wherein one of the sensor pins is provided as electrode sheet and the other one of the sensor pins is provided as wire mesh;
wherein the sensor pin provided as wire mesh is oriented parallel with respect to the sensor pin provided as electrode sheet;
wherein between the sensor pin provided as electrode sheet and the sensor pin provided as wire mesh a layer of non-conducting and liquid permeable material is provided;
wherein in particular the wire mesh is oriented pointing towards a position of expected leakage.

5. The leakage sensor of according to claim 1,
wherein at least two sensor pins forming a sensor unit are provided as wires being intertwined with each other;
wherein one of the two sensor pins is covered with a layer of non-conducting and liquid permeable material.

6. The leakage sensor of claim 1,
wherein at least two sensor pins forming a sensor unit are provided in a fork-like manner positioned interlocking with each other and separated from each other by a layer of non-conducting and liquid permeable material.

7. The leakage sensor of claim 1,
wherein one of the sensor pins is an actual carbon steel cooling unit.

8. The leakage sensor of claim 4,
wherein the sensor pins are made of galvanized steel and/or the non-conducting and liquid permeable material has sufficient heat resistance and in particular is made of glass fiber or paper.

9. The leakage sensor of claim 4,
wherein the layer of non-conducting and liquid permeable material has a thickness of less than 10 mm and particularly less than 5 mm.

10. A heating unit for an absorption cooling device for a recreational vehicle, comprising:
a boiler provided with a boiler insulation and a in particular electrical heating element;
wherein the boiler is configured to be coupled to an absorber and a condenser of the absorption cooling device;
wherein the heating unit has a leakage sensor that comprises
a voltage source and at least two sensor pins;
a voltage detection unit connected in series with the two sensor pins or a thermistor connected in parallel with the sensor pins;
wherein at least one of the at least two sensor pins are electrically connected to one pole of the voltage source and at least one other sensor pin of the at least two sensor pins is connected to the other pole of the voltage source or to ground, and wherein the sensor pins located in the boiler insulation of the heating unit of the absorption cooling device;
wherein the sensor pins of the leakage sensor are located in the boiler insulation of the heating unit.

11. The heating unit of claim 10,
wherein the boiler insulation surrounds the boiler and the heating element in radial direction with respect to the longitudinal axis of the boiler.

12. The heating unit of claim 10,
wherein the leakage sensor is provided as described in claim 4;
wherein the sensor pin provided as wire mesh is surrounding the boiler in the radial direction with respect to the longitudinal axis of the boiler;
wherein between the sensor pin provided as wire mesh and the boiler a layer of non-conducting and liquid permeable material is provided; and,
wherein the sensor pin provided as electrode sheet is surrounding the sensor pin provided as wire mesh in the radial direction with respect to the longitudinal axis of the boiler;
wherein in particular the boiler is covered with some mineral wool.

13. The heating unit of claim 10,
wherein various sensor units are provided; and,
wherein the sensor units are distributed in the boiler insulation along the length and the depth of the boiler insulation and, in particular are provided also in an area of the boiler insulation in which the occurring temperature is expected to be of about 100° C. and less.

14. An absorption cooling device for a recreational vehicle, comprising:
a condenser;
an evaporator;
an absorber coupled to each other;
a control system; and
a boiler provided with a boiler insulation and a in particular electrical heating element;
wherein the boiler is configured to be coupled to an absorber and a condenser of the absorption cooling device;
wherein the heating unit has a leakage sensor that comprises
a voltage source and at least two sensor pins;
a voltage detection unit connected in series with the two sensor pins or a thermistor connected in parallel with the sensor pins;
wherein at least one of the at least two sensor pins are electrically connected to one pole of the voltage source and at least one other sensor pin of the at least two sensor pins is connected to the other pole of the voltage source or to ground, and wherein the sensor pins located in the boiler insulation of the heating unit of the absorption cooling device;
wherein the sensor pins of the leakage sensor are located in the boiler insulation of the heating unit.

15. The absorption cooling device of claim 14, wherein the control system is connected to the voltage detection unit or to the thermistor and transmits an error signal and/or shutting down the absorption cooling device, in particular the heating unit of the absorption cooling device when determining the occurrence of leakage based on the signals received from the voltage detection unit or from the thermistor.

16. (canceled)

17. A method for operating an absorption cooling device, comprising the steps of:
measuring an electrical resistance and/or conductivity in the periphery of the boiler of the absorption cooling device;
comparing the measured data with at least one predetermined desired, threshold and/or reference value; and
controlling the absorption cooling device, in particular the heating unit of the absorption cooling device depending on the received result of the conducted comparison.

18. The method of claim 17,
wherein measuring the electrical resistance and/or conductivity in the periphery of the boiler is performed continuously, periodically and/or selectively.

19. The method of claim 1,
wherein the measured periphery of the boiler is in the inner of the boiler insulation of the absorption cooling device.

20. The method of claim 17,
wherein besides the electrical resistance and/or the conductivity, also other properties and/or parameters of the absorption cooling device are measured and considered in the conducted comparison.

21. The method of claim 20,
wherein at least one of the other properties and/or parameters of the absorption cooling device is a flow rate, velocity and/or current and/or other similar of these characteristics indicating properties and/or parameters of the absorption cooling device.

22. The method of claim 17,
wherein the absorption cooling device, and in particular the heating unit of the absorption cooling device is shut down, when a result of the conducted comparison indicates a non-negligible leakage for the absorption cooling device and/or a secure continuation of the operation of the absorption cooling device cannot be guaranteed.
